(19) United States
(12) Patent Application Publication
(10) Pub. No.: US 2007/0261090 A1
(43) Pub. Date: Nov. 8, 2007

(54) Interactive television application distribution, control, and communication system and methods

(76) Inventors: Eric B. Miller, Portland, OR (US); Charles F. Newby, Evergreen, CO (US)

Correspondence Address: GAZDZINSKI & ASSOCIATES, 11440 WEST BERNARDO COURT, SUITE 375, SAN DIEGO, CA, 92127, US

(21) Appl. No.: 11/728,234

(22) Filed: Mar. 23, 2007

Related U.S. Application Data
(60) Provisional application No. 60/785,871, filed on Mar. 24, 2006.

(51) Int. Cl. H04N 7/173; H04N 7/16

(52) U.S. Cl. 725/100; 725/135; 725/136; 725/110; 725/112; 725/113

(57) ABSTRACT

Apparatus and methods for implementing the distribution of multiple content-related (e.g., interactive television or “iTV”) applications to geographically separated information receivers of differing capabilities. In one embodiment, the (iTV) application is independently selected, loaded, and executed by each of the information receivers. The invention advantageously provides for control of the distribution of multiple, different iTV applications distributed from multiple, different content provider control systems to multiple, different information receivers, as well as the communication of specific iTV application information data between at least one control system and multiple, iTV application information receivers. Communication of control information between multiple iTV application information receivers and content provider control systems, and the communication of interactive user information between multiple, iTV application information receivers and content provider control systems, is also provided for.

### PRIORITY

This application claims priority to U.S. provisional patent application Ser. No. 60/785,871 filed Mar. 24, 2006 of the same title, which is incorporated herein by reference in its entirety.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

1. Field of the Invention

The present invention relates to the field of communications and content delivery, and specifically in one aspect to improved apparatus and methods for providing and operating an interactive multimedia environment.

2. Background of the Invention

Over the last decade, various systems have been designed to distribute executable software from a control system to geographically separated information receivers. A well-known example of a system designed to distribute executable application code from a control system is the Internet-based Java™ enterprise architecture described by J. Gosling et al in The Java Application Programming Interface, Volume 2, Addison-Wesley, 1996 wherein, in response to a user action, a domain's application server sends applet code objects to the connected browser whereupon the application code is loaded, started, and executed within a context set by the user machine (Java is a trademark of Sun Microsystems, Inc.). Another example of such a system is described by G. Anderson, Enterprise JavaBeans Component Architecture, Designing and Coding Enterprise Applications, Prentice-Hall, 2002 wherein, in response to a user action, a domain's application server executing an Enterprise JavaBean component sends client application code to the connected browser whereupon the application client code is executed within a context set by the user machine (JavaBean is a trademark of Sun Microsystems, Inc.).

The Multimedia Home Platform architecture described in the Digital Video Broadcasting (DVB); Multimedia Home Platform (MHP) Specification 1.0.3, incorporated herein by reference in its entirety, is a system designed to enable applications to execute on enhanced television receivers. Integral to the MHP platform is the capability to distribute executable application code wherein, in response to the viewer tuning a specific channel, the viewer's information receiver processes signaling information and Java application client code objects broadcast by the television network's control system whereupon the code objects may be selectively loaded, started, and executed within the context of its Java virtual machine.

Similar to the MHP platform, the OpenCable Application Platform (OCAP) architecture described in the OpenCable Application Platform OCAP 1.0 Profile OC-SP-OCAP1.0-I16-050803 specification, incorporated herein by reference in its entirety, provides functionality wherein, in response to the viewer tuning a specific channel or upon receiving a signal from an out-of-band communications channel, the viewer's information receiver processes signaling information and Java application client code objects broadcast by the television network's control system whereupon the code objects may loaded, started, and executed within the context of its Java virtual machine.

The Enhanced Television (eTV) system, partially described in Enhanced TV Application Messaging Specification OC-SP-ETV-AM-I02-050727, incorporated herein by reference in its entirety, specifies another platform wherein application code is distributed to information receivers whereupon it is executed within the context of platform capabilities.

Representative examples of prior art in the field in addition to the above include U.S. Pat. Nos. 5,666,293 (Metz, et al), 6,876,434 (Kawakami, et al), and 6,941,341 (Logston, et al), each of the foregoing incorporated herein by reference in its entirety, which disclose methods and apparatus for the distribution of operating system, middleware, and application code objects to their respective remote information receivers.

A close examination of prior art systems and techniques reveals that none provide a robust means for the distribution of application code and data objects from disparate content providers, across heterogeneous networks, and to geographically separated, remote information receivers with different functional capabilities. Additionally, none of the existing systems provide means for the signaling and dynamic delivery of code and data objects that may be needed by such geographically separated application clients executing on information receivers with such different capabilities. Moreover, none of the prior art systems or techniques provide means for each geographically separated information receiver to dynamically signal at least one control system in order to provide information relating to its capabilities, general status, application state, and additional relevant information.

### SUMMARY OF THE INVENTION

In one aspect, the present invention generally pertains to a system that implements methods for the simultaneous distribution of multiple, different applications (e.g., “iTV” or interactive television) to geographically separated information receivers of differing capabilities, whereupon an iTV application is independently selected, loaded, and executed by each of the information receivers. The invention is particularly directed in one embodiment to: (i) controlling the distribution of multiple, different iTV applications distributed from multiple, different content provider control systems to multiple, different information receivers; (ii) the communication of specific iTV application information data between at least one control system and multiple, different iTV application information receivers; (iii) the communication of control information between multiple, different iTV application information receivers and at least one content provider control system; and (iv) the communication of interactive user information between multiple, different iTV application information receivers and at least one content provider control system.

In accordance with another aspect of the invention, a system and methods for the dynamic generation, adaptation, and distribution of application code and data objects from disparate content providers is disclosed. In one embodiment, the distribution comprises iTV applications distributed across heterogeneous networks, and to geographically separated information receivers with different functional capabilities.

In accordance with another aspect of the invention, the system comprises an internal iTV playlist wherein the process of creating said new version of the previously created internal iTV application playlist is responsive to an external playlist which uniquely describes events contributed by a plurality of different operative iTV applications.

In accordance with another aspect of the invention, the system comprises an iTV application development system with apparatus for creating new versions of the previously created internal iTV application playlists.

In another aspect of the invention, methods and apparatus for dynamically signaling for the delivery of code and data objects that may be needed by geographically separated application clients executing on information receivers with different capabilities is disclosed. Apparatus and methods are also provided for each geographically separated information receiver to dynamically signal at least one control system in order to provide information relating to its capabilities, status, state, and application information.

In accordance with another aspect of the invention, an iTV system is disclosed. In one embodiment, the system comprises a content production system; a network control system; and a communication system, responsive to the network control system, which distributes, controls, and communicates with a plurality of different iTV applications executing on a plurality of different network connected information receivers.

In accordance with another aspect of the invention, a receiver is disclosed. In one embodiment, the receiver comprises apparatus for creating and uniquely describing an iTV application in conjunction with its associated information assets and system events. In another variant, the receiver includes apparatus for creating a database for inputting, storing, and outputting said iTV application in conjunction with its associated information assets and system events. In yet another variant, the receiver includes apparatus for creating an internal playlist which uniquely describes system events associated with a plurality of said iTV applications in conjunction with each set of associated information assets.

In still another variant, the receiver includes apparatus for creating an external playlist which uniquely describes system events associated with an external source of a plurality of different video, audio, and at least one possible iTV application in conjunction with its associated information assets. In still other variants, the receiver includes apparatus for: (i) reconciling, modifying, and publishing a new version of said internal playlist in response to said external playlist whereby such reconciliation, modification, and publishing process is controlled by a hierarchy of rules; (ii) creating an intermediate information set consisting of said created iTV application in conjunction with its associated information assets in response to the execution of said published new version of the internal playlist; (iii) creating a control system output consisting of the combination of the said intermediate information set and said external source of different video, audio, and at least one possible iTV application and associated information assets; and/or (iv) transmitting said control system output to a plurality of different information receivers connected to a plurality of different networks.

In accordance with another aspect of the invention, apparatus within a plurality of different information receivers is disclosed, the apparatus enabling inputting said control system output, processing said video, audio, and at least one possible iTV application in conjunction with its associated information assets, selectively executing said iTV application, performing user interface input/output operations, and communicating iTV application user information to the control system.

In accordance with another aspect of the invention, a system is disclosed which comprises an iTV application development system with apparatus for developing and deploying an iTV application. In one variant, the iTV application comprises a Java Xlet.

In accordance with another aspect of the invention, a system is disclosed that comprises an iTV application development system with apparatus for creation, conversion, formatting, validation, and finalization of video, audio, graphics, and text information assets, and apparatus capable of associating said information assets with a specific iTV application.

In accordance with another aspect of the invention, a system is disclosed that comprises an iTV application development system having apparatus for creating a database for ingesting, cataloging, formatting, tagging, and storing in said database information assets associated with an iTV application, and apparatus in said database for retrieving, queuing, and outputting information assets associated with an iTV application for further use and processing.

In accordance with another aspect of the invention, a system is disclosed that comprises an iTV application development system with apparatus for creating an internal iTV application playlist that is responsive to the output of a database containing information assets and system events associated with an iTV application wherein said internal iTV application playlist is capable of providing unique associations between said database information asset items and the precisely timed system event items associated with said iTV application.

In accordance with another aspect of the invention, a computer language model is disclosed comprising in the exemplary embodiment the extended markup language (XML), combined with specialized extensions that provide unique associations of the information assets associated with said iTV application and with precisely timed events described by said internal iTV application playlist.

In accordance with another aspect of the invention, methods for creating the new version of the previously created internal iTV application playlist is disclosed. In one embodiment, the process is responsive to an external playlist which uniquely describes events contributed by a source of a plurality of video, audio, and at least one possible iTV application in conjunction with its associated information assets.

In accordance with another aspect of the invention, the system comprises an iTV application development system with: apparatus for creating an intermediate information set consisting of an iTV application, its associated information assets, and its associated system events; and apparatus for creating a control system output consisting of the combination of said intermediate information set with a source of a plurality of video, audio, and at least one possible iTV application in conjunction with its information assets and system events.

In accordance with another aspect of the invention, the system comprises an iTV application development system with: apparatus for creating an intermediate information set comprising an iTV application, its associated information assets, and its associated system events; apparatus for processing said intermediate information set such that it is adapted in a manner that makes it operative for transmission on a plurality of different networks; apparatus for processing said intermediate information set such that it is adapted in a manner that makes it operative within a plurality of different connected information receivers; and apparatus for communicating said intermediate information set to the control system and apparatus within the control system for creating a control system output consisting of the combination of control system messages, said intermediate information set, and a source of a plurality of video, audio, and at least one possible iTV application in conjunction with its information assets and system events.

In accordance with another aspect of the invention, the system comprises apparatus that enables transmission of the control system output of a cable television network, a switched telephone network, a wireless telephone network, a broadcast television network, a satellite television network or a plurality of different said networks.

In accordance with another aspect of the invention, the system comprises a plurality of information receivers each capable of processing an input consisting of a source of video, audio, and at least one possible iTV application in conjunction with its associated information assets, and control system messages which have been adapted to be operative on a cable television network, a switched telephone network, a wireless telephone network, a broadcast television network, a satellite television network, or a plurality of different said networks.

In accordance with another aspect of the invention, each information receiver is capable of communicating iTV application user information to at least one network control system connected to a cable television network, a switched telephone network, a wireless telephone network, a broadcast television network, a satellite television network or a plurality of different said networks.

In accordance with another aspect of the invention, an iTV system is disclosed that comprises a content production system, a network control system and a communication system responsive to the network control system that distributes, controls, and communicates with a plurality of different iTV applications executing on a plurality of different information receivers connected to a network. The network includes apparatus in the network control system for receiving the output from the content production system consisting of an iTV application in conjunction with its associated information assets and system events, means in the network control system for combining the output received from the content production system consisting of an iTV application in conjunction with its associated information assets and system events with at least one source of different video, audio, and possible iTV application, its associated information assets, and system events; and apparatus in the network control system for creating an output of said combination of received content production system output and said source of different video, audio, and possible iTV application in conjunction with its associated information assets, and system events.

In accordance with another aspect of the invention, the system comprises at least one iTV application processing system located within each of the plurality of different networks with apparatus for ingesting, validating, localizing, and storing the iTV application in conjunction with its associated information assets and system events; apparatus for creating and transmitting status, information asset request, and alert messages to at least one network control system; and apparatus for outputting at least one iTV application in conjunction with its information assets and system events to an iTV application object carousel generator.

In accordance with another aspect of the invention, the system comprises at least one iTV application object carousel generator located within each of the plurality of different networks with apparatus for ingesting, validating, and storing the output from at least one iTV application processing system; apparatus for creating at least one iTV application object carousel stream after processing the output from said iTV application processing system; and apparatus for outputting at least one said iTV application object carousel stream adapted to be operative on the local network.

In accordance with another aspect of the invention, the input from at least one connected network control system is adapted to be operative on a cable television network, a switched telephone network, a wireless telephone network, a broadcast television network, a satellite television network or a plurality of different said networks.

In accordance with another aspect of the invention, the input from at least one locally connected iTV application processing system is adapted to be operative one to a cable television network, a switched telephone network, a wireless telephone network, a broadcast television network, a satellite television network or a plurality of different said networks.

In accordance with another aspect of the invention, the system comprises a plurality of information receivers each capable of processing an input consisting of a source of video, audio, and at least one possible iTV application in conjunction with its associated information assets, and control system messages which have been adapted to be operative on to a cable television network, a switched telephone network, a wireless telephone network, a broadcast television network, a satellite television network or a plurality of different said networks.

In accordance with another aspect of the invention, each information receiver is capable of communicating iTV application user information to at least one network control system connected to a cable television network, a switched telephone network, a wireless telephone network, a broadcast television network, a satellite television network or a plurality of different said networks.

In accordance with another aspect of the invention, a host or client device for use in an iTV network is disclosed. In one embodiment, the device comprises a set-top box (STB) for use in a satellite or cable network, and comprises an iTV client application.

In accordance with another aspect of the invention, network server device for use in an iTV network is disclosed. In one embodiment, the device comprises an application for use in a satellite or cable network.

### BRIEF DESCRIPTION OF THE DRAWINGS

FIG. 1 is a block diagram of a first embodiment of the iTV application distribution, control, and communication system of the present invention.

FIG. 2 is a block diagram of a second embodiment of the iTV system of the present invention, applied to a broadband cable network.

FIG. 3 is a block diagram of an exemplary content provider production system including the application content server, application content database, application information server, and network management server.

FIG. 4 is a block diagram of exemplary application server and object carousel generator components that are integrated with a typical local television network.

FIG. 5 is a block diagram of an exemplary embodiment of the iTV application client according to the invention, showing the local network interface, iTV application lifecycle management, iTV application resource management, iTV application user interface, and iTV user information input/output.

FIGS. 6 and 7 are block diagrams of the exemplary end-to-end application delivery architecture according to one embodiment of the invention.

FIG. 8 is a block diagram of the exemplary application platform (AP) system architecture according to one embodiment of the invention (Concierge).

FIG. 9 is a graphical illustration of the exemplary Concierge application platform system operation.

FIG. 10 is a block diagram of the exemplary Concierge application platform NOC components and functions.

### DESCRIPTION OF THE PREFERRED EMBODIMENTS

Reference is now made to the drawings wherein like numerals refer to like parts throughout. Additionally, throughout the application various functions are ascribed to various systems located throughout a network.

As used herein, the term “application” refers in certain contexts generally to a unit of executable software that implements a certain functionality or theme. The themes of applications vary broadly across any number of disciplines and functions (such as communications, instant messaging, content management, e-commerce transactions, brokerage transactions, home entertainment, calculator etc.), and one application may have more than one theme. The unit of executable software generally runs in a predetermined environment; for example, the unit could comprise a downloadable Java Xlet™ that runs within the Java™ environment.

As used herein, the term “computer program” or “software” is meant to include any sequence or human or machine cognizable steps which perform a function. Such program may be rendered in virtually any programming language or environment including, for example, C/C++, Fortran, COBOL, PASCAL, assembly language, markup languages (e.g., HTML, SGML, XML, VoXML), and the like, as well as object-oriented environments such as the Common Object Request Broker Architecture (CORBA), Java™ (including J2ME, Java Beans, etc.) and the like.

As used herein, the term “server” refers to any computerized component, system or entity regardless of form which is adapted to provide data, files, applications, content, or other services to one or more other devices or entities on a computer network.

Additionally, the terms “selection” and “input” refer generally and without limitation to automated, semi-automated, user, or other input using without limitation computer programs, algorithms, a keypad, mouse, GUI interface, speech recognition system, remote control unit, touch screen, or other input device or process of the type well known in the art.

As used herein, the term “integrated circuit (IC)” refers to any type of device having any level of integration (including without limitation ULSI, VLSI, and LSI) and irrespective of process or base materials (including, without limitation Si, SiGe, CMOS and GAs). ICs may include, for example, memory devices (e.g., DRAM, SRAM, DDRAM, EEPROM/Flash, ROM), digital processors, SoC devices, FPGAs, ASICs, ADCs, DACs, transceivers, memory controllers, and other devices, as well as any combinations thereof.

The term “processor” is meant to include any integrated circuit or other electronic device (or collection of devices) capable of performing an operation on at least one instruction including, without limitation, reduced instruction set core (RISC) processors, CISC microprocessors, microcontroller units (MCUs), CISC-based central processing units (CPUs), and digital signal processors (DSPs). The hardware of such devices may be integrated onto a single substrate (e.g., silicon “die”), or distributed among two or more substrates. Furthermore, various functional aspects of the processor may be implemented solely as software or firmware associated with the processor.

As used herein, the term “memory” includes any type of integrated circuit or other storage device adapted for storing digital data including, without limitation, ROM. PROM, EEPROM, DRAM, SDRAM, DDR/2 SDRAM, EDO/FPMS, RLDRAM, SRAM, “flash” memory (e.g., NAND/NOR), and PSRAM.

As used herein, the term “database” refers generally to one or more tangible or virtual data storage locations, which may or may not be physically co-located with each other or other system components.

As used herein, the terms “video” and “image” refer to both still images and video or other types of graphical representations of visual imagery. For example, a video or image might comprise a JPEG or TIFF file, MPEG or AVC-encoded video, or rendering in yet another format.

As used herein, the terms “network” and “bearer network” refer generally to any type of telecommunications or data network including, without limitation, hybrid fiber coax (HFC) networks, satellite networks, telco networks, and data networks (including MANs, WANs, LANs, WLANs, internets, and intranets). Such networks or portions thereof may utilize any one or more different topologies (e.g., ring, bus, star, loop, etc.), transmission media (e.g., wired/RF cable, RF wireless, millimeter wave, optical, etc.) and/or communications or networking protocols (e.g., SONET, DOCSIS, IEEE Std. 802.3, ATM, X.25, Frame Relay, 3GPP, 3GPP2, WAP, SIP, DSM-CC, RTSP, UDP, FTP, RTP/RTCP, TCP/IP, H.323, etc.).

As used herein, the term “head-end” refers generally to a networked system controlled by an operator (e.g., an MSO or multimedia specific operator) that distributes programming to MSO clientele using client devices. Such programming may include literally any information source/receiver including, inter alia, free-to-air TV channels, pay TV channels, interactive TV, and the Internet. DSTBs may literally take on any configuration, and can be retail devices meaning that consumers may or may not obtain their DSTBs from the MSO exclusively. Accordingly, it is anticipated that MSO networks may have client devices from multiple vendors, and these client devices will have widely varying hardware capabilities. Multiple regional head-ends may be in the same or different cities.

As used herein, the terms “client device” and “end user device” include, but are not limited to, personal computers (PCs) and minicomputers, whether desktop, laptop, or otherwise, set-top boxes such as the Motorola DCT2XXX/5XXX and Scientific Atlanta Explorer 2XXX/3XXX/4XXX/8XXX series digital devices, personal digital assistants (PDAs) such as the RIM Blackberry®, “Palm®” family of devices, handheld computers, personal communicators such as the Motorola Accompli devices, Motorola Ojo SIP phone, J2ME equipped devices, cellular telephones and smartphones, personal music or media devices, or literally any other device capable of interchanging data with a network.

Similarly, the terms “digital consumer terminal (DCT)” and “host device” refer to any type of electronic equipment located within a user's premises and connected to a network. The term “host device” refers generally to a terminal device that has access to digital television content via a satellite, cable, or terrestrial network. The host device functionality may be integrated into a digital television (DTV) set. The term “DCT” includes such electronic equipment such as set-top boxes, televisions, Digital Video Recorders (DVR), gateway storage devices (Furnace), personal media devices (PMDs), and iTV devices or Personal Computers.

As used herein, the term “network agent” refers to any network entity (whether software, firmware, and/or hardware based) adapted to perform one or more specific purposes. For example, a network agent may comprise a computer program running in server belonging to a network operator, which is in communication with one or more processes on a DCT or other device.

As used herein, the term “DOCSIS” refers to any of the existing or planned variants of the Data Over Cable Services Interface Specification, including for example DOCSIS versions 1.0, 1.1, 2.0 and 3.0. DOCSIS (version 1.0) is a standard and protocol for internet access using a “digital” cable network. DOCSIS 1.1 is interoperable with DOCSIS 1.0, and has data rate and latency guarantees (VoIP), as well as improved security compared to DOCSIS 1.0. DOCSIS 2.0 is interoperable with 1.0 and 1.1, yet provides a wider upstream band (6.4 MHz), as well as new modulation formats including TDMA and CDMA. It also provides symmetric services (30 Mbps upstream).

Overview

In one salient aspect, the present invention discloses apparatus and methods for implementing the distribution of multiple content-related (e.g., interactive television or “iTV”) applications to geographically separated information receivers of differing capabilities. In one embodiment, the (iTV) application is independently selected, loaded, and executed by each of the information receivers. The invention advantageously provides for control of the distribution of multiple, different iTV applications distributed from multiple, different content provider control systems to multiple, different information receivers.

It also provides for the communication of specific iTV application information data between at least one control system and multiple, iTV application information receivers.

Communication of control information between multiple iTV application information receivers and content provider control systems, and the communication of interactive user information between multiple, iTV application information receivers and content provider control systems, is also provided.

Improved host device (e.g., set-top box) and network server configurations are also disclosed.

Exemplary Apparatus and Methods

Exemplary embodiment of the system, various component apparatus, and methods according to the present invention are now described in detail.

While the utility of the present invention can be understood in the exemplary context of an exemplary iTV system, it will be understood that the present invention is in no way limited to such applications or contexts.

Moreover, while the exemplary iTV system architecture described is implemented such that it meets the requirements of a cable television system, those skilled in the art will recognize that the present invention applies equally to the implementation of systems (iTV or otherwise) for switched telephone, wireless telephone, terrestrial broadcast, millimeter wave, and satellite systems.

It should further be understood that the configuration shown is only one embodiment of the invention, and performing the same or similar functions, or disposing or distributing hardware (e.g., integrated circuit), software or firmware components or processes at other nodes in the network is consistent with other embodiments of the invention.

Also, the various systems than make up the invention are typically implemented using software running on semiconductor or integrated circuit (IC) microprocessors or other computer systems the use of which is well known in the art. Similarly, the various process described here are also preferably performed by software running on a microprocessor, although other implementations including firmware, hardware, or even human-performed steps are also consistent with other embodiments of the invention.

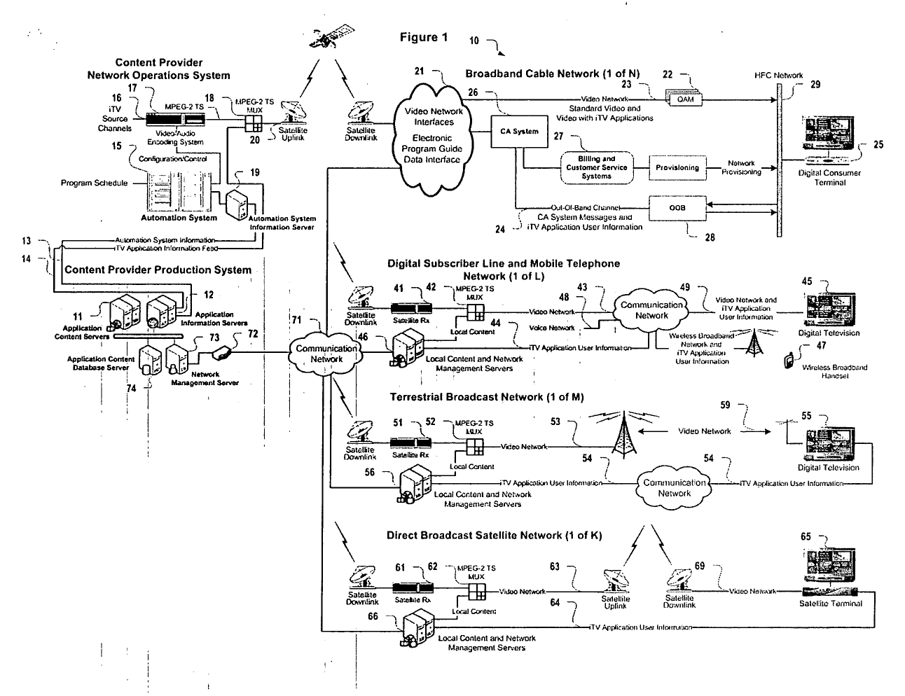

Referring now to FIG. 1, a first embodiment of the system is described. As shown in FIG. 1, the exemplary iTV system 10 comprise a plurality of network agents including one or more application content servers (ACS) 11; one or more of application information servers (AIS) 12; iTV source channel inputs 16 processed by a digital video/audio encoding system 17 (e.g., a system that encodes in accordance with the prevailing video/audio standards, such as e.g., MPEG-2, MPEG-4, AVC, H.264, etc.)); a digital multiplexer 18; a satellite uplink 20; an automation system 15; and an automation system information server (ASIS) 19.

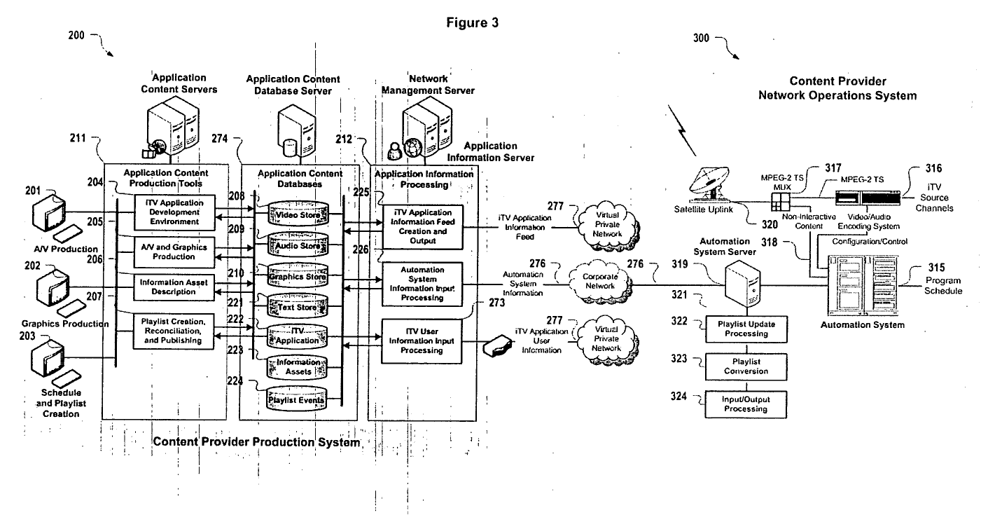

As shown in FIG. 3, a suite of application content production tools (ACPT) 211 which create, package, catalogue, store in a application content database server (ACDS) 274, and, based on system events associated with the iTV application, queue iTV application content for output to the AIS 12, are utilized.

Referring again to FIG. 1, based on the content provider program scheduler input, the automation system 15 generates an output that is sent to the ASIS 19 whereupon it generates an automation system information (ASI) stream 13, which is sent to the AIS 12. The ASI stream 13 contains a description of the specific video, audio, the one or more possible iTV applications, the information assets, and the system events required for the proper creation, from each iTV source channel 16, of each iTV channel output for transmission by the satellite uplink 20. The AIS 12 reconciles ASI stream 13 description information for each iTV source channel with the related description information created in the ACS 11 to synchronously ingest each required iTV application, its associated information assets, and its system events from the ACDS 274 whereupon these assets are output to the AIS 12 which creates the IAI feed 14 which is sent to the digital multiplexer 18 whereupon it is properly combined with iTV source channels 16 that are output from the video/audio encoding system 17 and output to the satellite uplink 20 for transmission to various receiving network interfaces 21, 41, 51, and 61.

At the local cable head-end, services containing iTV channel applications are received by the video network interface 21, converted to a distribution format 23, QAM modulated by 22, connected to the hybrid fiber-coax (HFC) network 29 whereupon said services are transmitted on the network, and received, decoded, and output to video, audio, and other possible devices by the digital consumer terminal (DCT) 25. It will be recognized for example that the DCT may have associated with it one or more “client” devices or environments, such as for example a local Wi-Fi or PAN (personal area network), UpnP or MoCA devices, USB devices, local media players and/or recorders, and so forth.

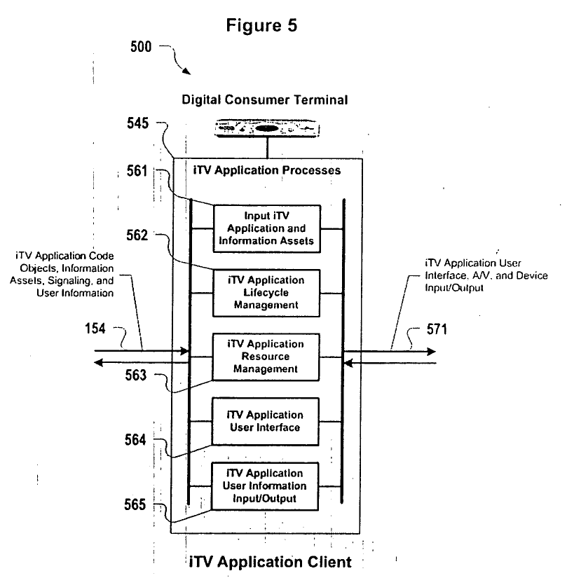

As shown in FIG. 5, when a television channel containing an available iTV application is selected by the user, the DCT 25 conditionally loads, starts, and executes the iTV application client 545 whereupon the application generates appropriate video, audio, and user interface outputs 571; processes network, user interface, and iTV application information inputs and, in response to user interaction, the DCT 25 transmits iTV application user information 24 first to the out-of-band receiver 28 next to the conditional access system 26; then through the video network interface 21, through the communication network 71, where it is received by the communication network device 72, and, finally, to the network management server (NMS) 73.

The NMS 73 pre-processes the iTV user information 24, then outputs it to the AIS 12 whereupon processing is performed that may respond to the iTV application user information 24 in such a manner that different video, audio, or iTV application and its associated information assets may be ingested by the ACS 111 and sent to the AIS 112 whereupon such additional content may be distributed by the IAI feed 14.

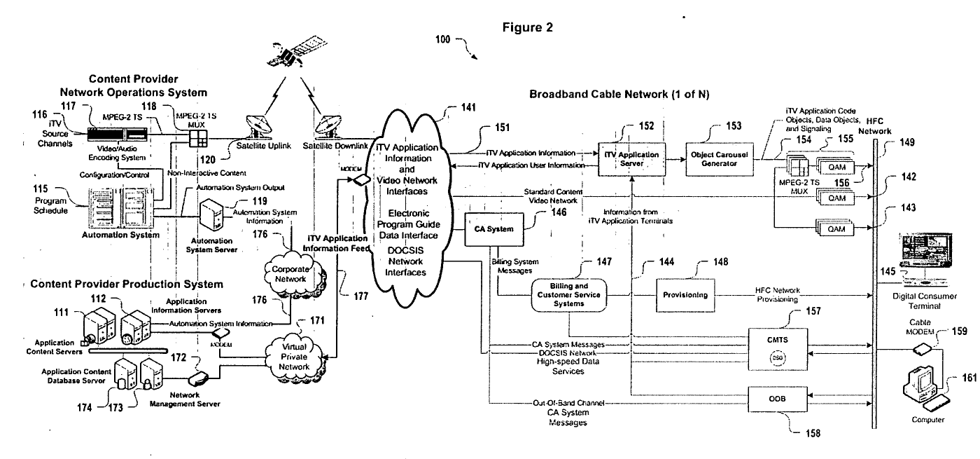

Referring to FIGS. 2 and 3, a second embodiment of the iTV application system 100 includes an ACPT suite 204, 205, 206, and 207 executing on the ACS 211 that is used to directly produce, convert, and format iTV content whereupon it is published for packaging, cataloging, and queuing on the ACS 112. The iTV AIS 112 uses the automation system information 176 to synchronously requested video, audio, one or more possible iTV applications and its associated information assets from the ACS 111 whereupon the AIS 112 generates the IAI feed 177 that is transmitted to the target cable head-end(s) through the network interface 141 to a local iTV Application Server (IAS) 152. The IAS 152, an Object Carousel Generator (OCG) 153 and at least one group of MPEG-2 TS multiplexer-quadrature amplitude modulation (QAM) devices 155 in the illustrated embodiment, transmits the IAS 152 output to the hybrid fiber-coax (HFC) network 149 and at least one DCT 145 connected to the HFC network 149.

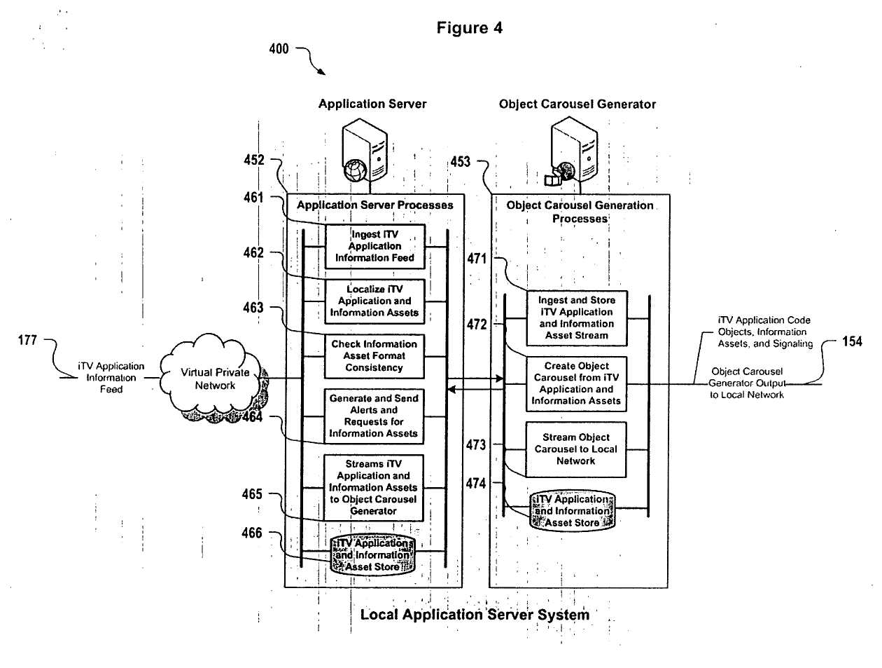

As shown in FIG. 4, the IAS 452 ingests the IAI feed 177, localizes the content, and stores at least one iTV application and its associated information assets; performs information consistency checks; generates new information asset requests and alerts; sends and receives control system messages; and streams its output to the OCG 453. The OCG 453 ingests, stores, and create an object carousel from the iTV application information output 475 from the IAS 452; connects the object carousel to the MPEG-2 TS multiplexer-quadrature amplitude modulation (QAM) 155, transmits the IAS 152 output to the hybrid fiber-coax (HFC) network 149, and at least DCT devices 145 connected to the HFC network 149.

As shown in FIG. 5, when a television channel containing an available iTV application is selected by the user, the DCT 25 conditionally loads, starts, and executes the iTV application client 545 whereupon the application generates appropriate video, audio, and user interface outputs 571; processes network, user interface, and iTV application information inputs; and, in response to user interaction, the DCT 25 transmits iTV application user information 24 first to the out-of-band receiver 28 next to the conditional access system 26; then through the video network interface 21, through the communication network 71, where it is received by the communication network device 72, and, finally, to the network management server (NMS) 73. The NMS 73 pre-processes the iTV user information 24, then outputs it to the AIS 12 whereupon processing is performed that may respond to the iTV application user information 24 in such a manner that different video, audio, or iTV application and its associated information assets may be ingested by the ACS 11 and sent to the AIS 12 whereupon such additional content may be distributed by the IAI feed 14.

Those skilled in the art will recognize that in addition to the preceding method for communicating the output from the IAS 152 and OCG 153, said output can also be communicated using the Data Over Cable Service Interface Specification (DOCSIS) high-speed data network through which the Cable Modem Termination System (CMTS) 157 places said output on the HFC network 149 whereupon, in accordance with the present invention, the cable MODEM 159 and computer 161 perform all of the functions of the DCT information receiving device 145.

As can be seen in FIG. 1, in addition to the two preferred embodiments already described in detail, those skilled in the art will recognize that the system implementation of the either the first or the second preferred embodiment can be utilized to create an iTV system on a switched telephone, a wireless telephone, a digital broadcast television, or a satellite television network.

FIGS. 3, 4, and 5 show internal block diagrams of the components used to construct various embodiments of the present invention; that is, the content provider production system 200, the content provider network operations center 300, the application server 400, and application client 500 respectively. Additionally, FIG. 3 shows an internal block diagram of the content provider network operations system including the iTV source channels, automation system, automation system server, video/audio encoding system, digital multiplexer, and satellite uplink is described.

These components are now described in greater detail.

An application content production tool suite (ACPT) 211 executing on the ACS 11 adds dynamically programmed enhancements to content that is pre-recorded, formatted, and stored within the ACS 11 or content that is either pre-recorded or live but that is ingested as iTV source channels 16. The ACPT 211 includes at least one or more of the four functional components: (i) an application program integrated environment (IDE) 204 with capabilities to assist in the development of application program code, embedded video, audio, text, pop-ups, information tickers, widgets, actions, interfaces to external production tools, and libraries that allow third-party developer enhancements plus a set of emulation, integration, and test tools within the IDE 204 that allows the developer to fully simulate the viewer experience; (ii) a tool set 205 containing asset creation, conversion, formatting, validation, and finalization tools for video, audio, graphics, and text information that will be utilized by executing iTV applications; (iii) an asset description tool 206 which creates a hierarchical description of iTV application information asset that uniquely describes iTV application; and (iv) a playlist creation, reconciliation, and publishing tool 207 which creates, reconciles, and publishes a first internal playlist of system events associate with an iTV application and a second internal playlist that has been modified in response to an external playlist of system events.

An exemplary application content database server (ACDS) 274 provides at least one or more of the following four functional capabilities: (i) provides application content databases 208, 209, 210, and 221 used by the IDE 204 to ingest, catalogue, format, store, retrieve, and queue application program code, video, audio, graphics, and text information collected into the iTV application, information asset, and playlist event output databases 222, 223, and 224; (ii) supplies a unique identifier to each asset that allows a producer to quickly call up application program code, video, audio, graphics, and text information for distribution within the iTV application information stream 14; (iii) organizes iTV source channel 16 enhancements with required assets within the database, triggered by identifier values, which allows the use of the automation system 15 and its playlists for broadcasting enhancements output within the ASI stream 13; and (iv) creates an interface to the AIS 12 for the purpose of performing required real-time, near real-time, and non real-time transactions the on the ACD including those related to: installing, updating, and removing iTV applications; creating messages that identify which AIS 12 is to be the recipient of iTV application user information 24 communications from specific iTV applications; iTV application content information including message packets, triggers, and event-sensitive information which is associated with specific content e.g., a video/audio clip that is to be broadcast by a iTV source channel 16 when a specific event occurs.

An application content server (ACS) 11, part of the content provider production system, hosts the ACPT 211 and ACDS 274. Simultaneously, the ACS 11 creates the internal playlist associated with an iTV application and its information assets. On demand from the AIS 12, the ACS 11 output an iTV application, its information assets, and its internal playlist events.

An application information server (AIS) 12, part of the content provider production system, which receives the output of the ACPT suite 204, 205, 206, and 207 executing on the ACS 211 which consists of an iTV application, its associated information assets, and its associated internal playlist events. Simultaneously, the AIS 12 receives the ASI stream 13 which consists of information describing a playlist consisting of a precisely timed schedule of events relating to a group of iTV source channels 16. The AIS 12 reconciles its internal iTV application playlists with the playlist transmitted in the ASI stream 13, creates an output that combines iTV system playlist event control information, operative iTV applications, and the associated information assets as the iTV application information (IAI) 14 stream.

An iTV application server (IAS) 152 located at the cable headend which ingests, processes, and packages, based on any required localization of the content, the iTV application information and outputs the iTV application program and information binaries to an object carousel generator (OCG) 153 or directly to the digital multiplexer 154 for distribution to the iTV application clients executing on digital consumer terminals (DCT) 145.

An object carousel generator (OCG) 153 located at the cable headend which receives iTV application program and information binaries from the IAS 152, divides them into an information object carousel, and, using a robust distribution protocol, outputs them to the HFC network 149 via the MPEG-2 TS multiplexer 154 and QAM device 142.

An application client 545 executing on DCT devices 25 that inputs the iTV application code objects and its associated information assets; manages the application lifecycle, application resources, and user interaction interfaces; and performs application and interactive user information input/output.

Exemplary Implementation—End-to-End Application Delivery Architecture

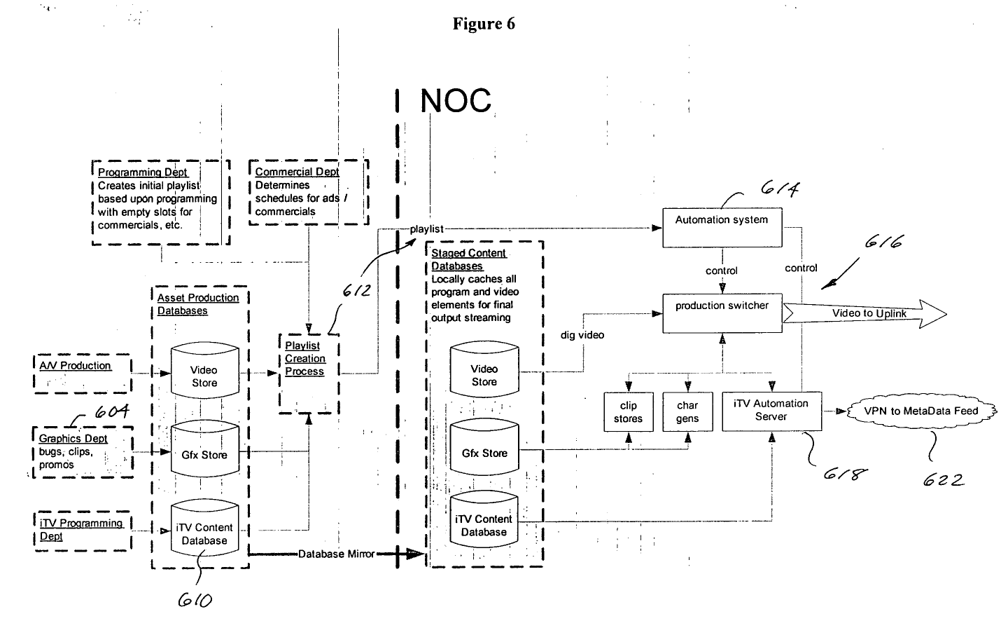

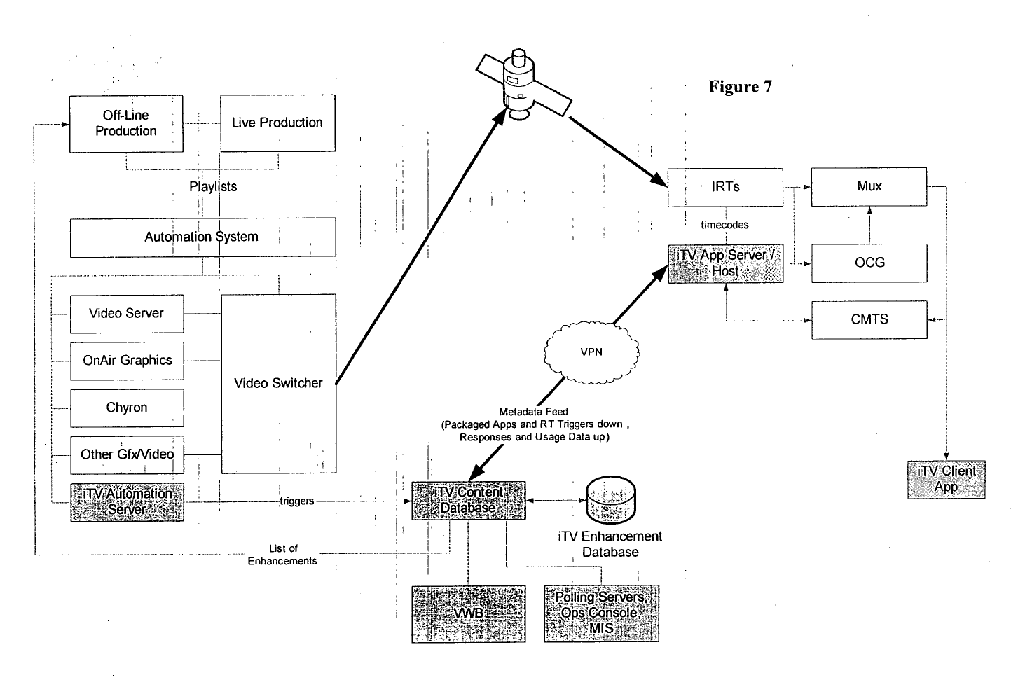

Referring now to FIGS. 6 and 7, one exemplary embodiment of an End-to-End Application Delivery Architecture (EADA) according to the invention is described. While the following description is cast in terms of an exemplary iTV Application Platform system architecture, it will be recognized that this is merely for purposes of illustration, and the invention is in no way so limited.

This architecture defines each of the major processes and architectural components required for delivering iTV applications and data from a broadcaster to an end user in accordance with one embodiment of the invention.

The end-to-end iTV Application Platform architecture, as shown in FIGS. 6 and 7, comprises several components added to standard broadcast and cable networks including:

(i) iTV Production Tool Suite—The iTV production tools 602 give the producer the ability to add pre-programmed enhancements to both pre-recorded and live broadcasts. In accordance with one embodiment of the invention production tools include three components: 1) Graphics and asset creation/formatting tools 604; 2) iTV application development tools (not shown); and 3) an iTV content database 610.

An iTV application comprises of software and resources or assets. The software acts upon the assets by, for example, displaying a graphic, rendering text, or playing an audio clip. Software engineers write software. Graphic artists create graphic resources. Audio engineers create audio clips. And producers place those elements into a video program to create the interactive experience. To make each of these elements available to the producer they are stored in an iTV Content Database in the illustrated embodiment, although other storage locations and models may be used consistent with the invention. These tools are developed as Plug-ins to a broadcaster's current production tools, and allow the insertion of questions, pop-ups, and ticker headlines for applications that are already signaled, or whole new applications where appropriate.

These tools are further designed to have extensible libraries of actions and widgets, so as to allow the palette of choices to expand as the broadcaster and other third parties develop additional enhancements for use.

For off-line production, these tools allow a greater degree of control over selecting, customizing, and previewing enhancements, fully simulating the viewer experience. For live events, the tools allow the insertion of pre-set enhancements with fewer options for customizing or previewing the enhancements.

The output of the exemplary embodiment of the production tools comprises a playlist 612, which feeds the broadcaster's production automation system (PAS) 614, also used for controlling the On-Air Graphics System and video switchers 616.

(ii) iTV Automation System Server—This server 618 is preferably located at the broadcaster's Network Operations Center (NOC), although other locations may readily be used. The iTV automation system server receives messages from the broadcaster's production automation system when, e.g., each marked enhancement is cued to air. The messages received by this server represent the playlist entries that are to be triggered and are used to call up entries in the iTV content database 610, which performs the physical insertion of the enhancements into the iTV metadata feed 622.

(iii) iTV Content Database—An important aspect to being able to place iTV applications and data into a video program is the content database 610. This database provides a unique tag or identifier which allows a producer to quickly call up an application, or a set of data to feed an application. That data set could include for example text, graphics, or any other assets.

In a shopping application for example, the additional data may include stocking numbers, prices, and color or size options. In a voting or polling application, this data may include e.g., questions and multiple choice answers. In a sports application, it may include statistics on the player being profiled. A music application may utilize for example facts about the artist currently playing.

Organizing all of the assets and enhancements within a database, triggered by ID numbers, advantageously allows the use of automation systems and playlists for broadcasting enhancements, much in the same way that video programs and graphics overlays are triggered today.

The output of the illustrated embodiment of the content database 610 is the iTV application metadata feed 622. This feed contains a mix of real-time and non real-time data. The non real-time data includes applications which are being broadcast to headends where they will be staged for playout across one or multiple channels. Specific messages in this metadata feed may include for example those related to installing, updating, and removing applications. Other messages may identify specific servers run by broadcasters which are to be the recipients of back channel communications from their applications.

Real-time data may include message packets, triggers, and context-specific data which is tied to a specific frame or clip of video broadcast from the NOC. The Metadata Feed can also include routing information, to allow headends to automate the process of sending and receiving messages for specific channels, applications, and even end users.

The iTV application metadata feed 622 may be sent to the iTV application servers in cable, DBS, terrestrial broadcast, and telco headends across the country. Some data will be unique for each network environment. Some data can also be made portable across all of the above networks.

(iv) Metadata Distribution VPN—A Virtual Private Network (VPN) of the type well known in the networking arts is used in one embodiment to distribute the iTV metadata feed to the population of cable headends that are running the iTV application server. For example, for the three U.S. major broadcasters (ABC, CBS, NBC), this signal may first be sent to local affiliates before being retransmitted to local cable headends (with locally-inserted advertisements or modified program lineups). For cable-only channels, this signal may be sent directly to the cable headend or DBS uplink facility.

In some cases, the broadcaster may re-integrate the video and metadata signal at a “super” headend and then distribute the signal over fiber to several regional or local headends, simplifying the system through concentration of the essential components.

It will be appreciated that security measures other than VPN may be utilized to tunnel the information across an untrusted network, such as e.g., IEEE-802.11i, 802.1x with RADIUS server, etc., or alternatively a partly or wholly physically secure network may be used.

(v) iTV Application Server—This server is located in the exemplary embodiment at local (or sometimes regional) cable headends, although other locations may be used. The iTV Application Server receives the iTV Application metadata feed 622 from the iTV Application Metadata Server, packages that metadata based on any required localization of the content, and outputs the packaged data and application binaries to an object carousel generator or multiplexer for distribution to the iTV zpplication clients running on OCAP/eTV-compliant host devices.

Exemplary Implementation—Concierge Application Platform

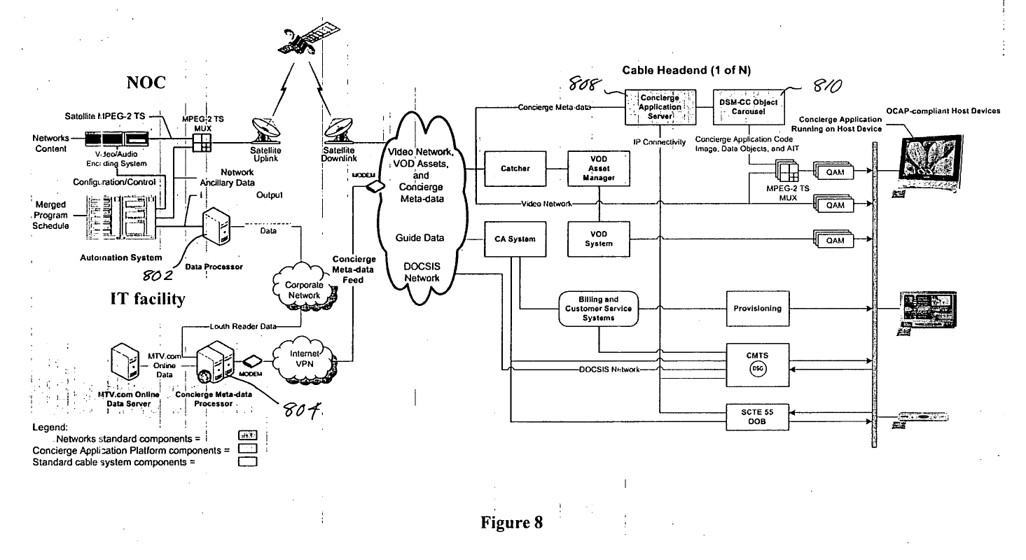

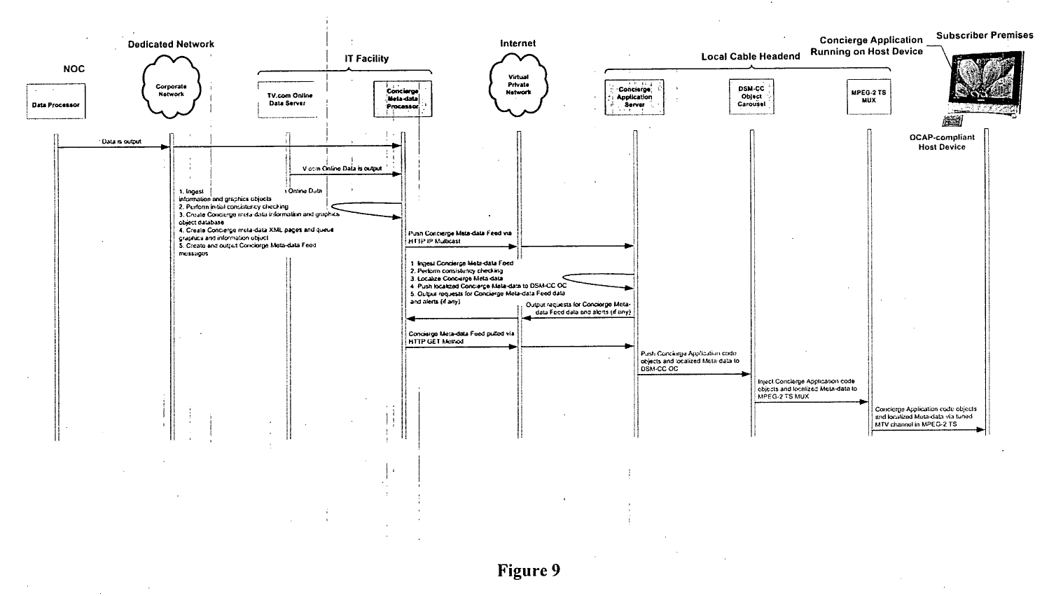

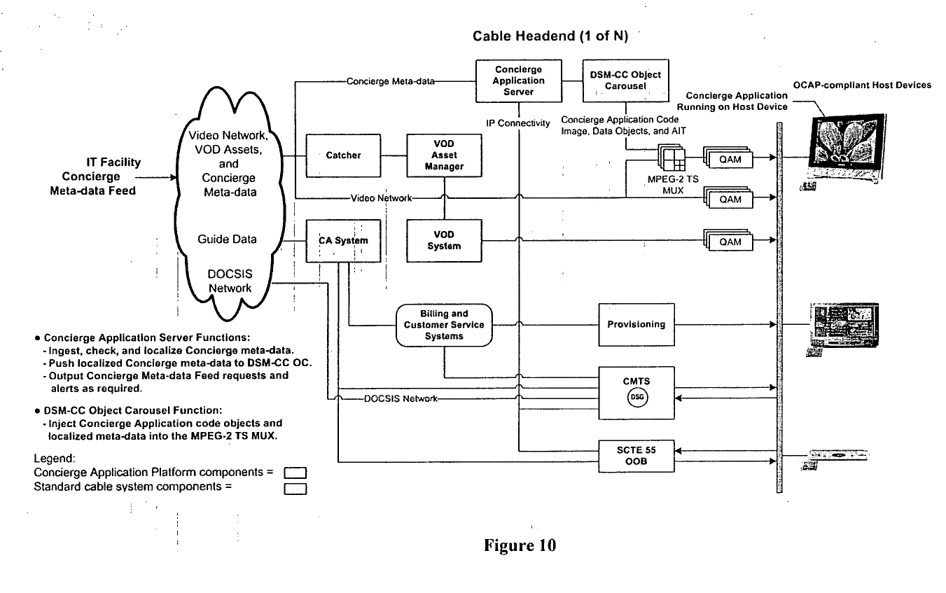

Referring now to FIGS. 8-11, Applicant's exemplary Concierge application platform (AP) and associated architecture are described in detail.

The primary purpose of the Concierge application is to welcome the network subscriber to a given domain with a unique viewer experience designed to help the subscriber discover which content (e.g., music videos) are currently playing, or soon will be, as well as to discover links to other channels and content. While the following embodiments are described in terms of an exemplary “MTV®” (Music Television) environment, this is for illustration purposes only, and it will be recognized that the principles of the invention can be extended to other environments and domains, and in fact other types of networks.

Based on subscriber preferences known a priori or relative to the current viewing context, Concierge allows the content (e.g. MTV) networks to push content to the subscriber including: (i) MTV.com Online Content—MTV Web site content that is synchronized to on-air informational, graphical, or other content processed for distribution as program meta-data to be utilized by Concierge; (ii) Regionalized Content—content classified as national, regional, and local; (iii) Cross—network Content—MTV Networks channels, programming, and services that can encourage subscriber retention and reinforce the MTV brand; and (iv) Live Content—content and data associated with a live video or data cast event.

Moreover, the exemplary Concierge application can utilize “X” TV (e.g., MTV) channels as incubators for new iTV applications e.g., an on-screen eTV application such as Control Freak, purchase CDs, DVDs, or event tickets, and also facilitate the building of links to other services e.g., information alerts via mobile telephone or downloads of songs, ring-tones, or short clips.

The exemplary MTV-based Concierge application comprises an OCAP-compliant bound application that is signaled on three MTV channels: MTV Hits, MTV Jams, and MTV 2. In one configuration, once tuned to an MTV channel, the application must not require a ‘tune away’ operation in order to perform properly. The exemplary Concierge application platform architecture also encompass scenarios where the three MTV channels are in the same transport stream, as well as situations where they are broadcast in multiple transport streams.

In one variant, in order to maximize portability to markets (e.g., Europe and Asia), wherever possible, the Concierge application is restricted use of GEM-compliant APIs.

Typically, MTV program and video lineups are published n hours in advance (published daily at a prescribed time window), but may change dynamically throughout a day, on several minutes notice, or with no notice at all as in the case where the control room operator adds, drops, or substitutes a program. In addition, the Concierge application is adapted to handle live events and, although these programs will typically be scheduled in advance, they may not have a fine program schedule timeline generated for them.

In one variant, no embedding of data into the MTV video feeds sent via satellite to cable headends is utilized.

Moreover, the exemplary Concierge application performance is adapted to be robust under conditions where MTV program schedule and context sensitive meta-data is missing and/or uncorrelated to the current on-air program.

FIGS. 8-10 illustrate various aspects of one embodiment of end-to-end Concierge Application Platform architecture. This architecture comprises the following components:

(i) Data Processor—The server 802 that generates the required data (e.g., Louth Reader Data) from program schedule data that it receives from a source and outputs it to the Concierge meta-data processor 804.

(ii) Meta-Data Processor—The high-performance server 804 that generates the Concierge meta-data feed from program information and schedule data that it receives from “X” TV (e.g., MTV.com Online Data Processor) and the Data Processor 802 respectively. Functions of the exemplary Concierge meta-data processor include: ingestion of data; performance of initial schedule, information, and graphics objects consistency checks; checks of channel schedule against e.g., real time data, and adjustment of the database accordingly; creation of information and graphics object database; create Concierge meta-data XML pages; creation of Concierge meta-data feed messages; and pushing the Concierge meta-data feed.

(iii) Concierge Application Server—The server 808, located at the local cable headend in the exemplary embodiment, hosts the Concierge Application at the local cable headend, receives and processes the Concierge meta-data feed, and outputs localized content to the Concierge DSM-CC Object Carousel for distribution to the Concierge application clients running on the local OCAP-compliant host devices (e.g., DSTBs). The server 808 also perform consistency checking and alert/data request if required.

(iv) DSM-CC Object Carousel—The Digital Storage Media Command and Control (DSM-CC) object carousel 810, located at the local cable headend in the exemplary embodiment, spools Concierge application-related objects to the local digital video multiplexer suite which injects them into the appropriate MPEG-2 Transport Stream(s).

(v) Meta-Data Distribution VPN—The Internet Virtual Private Network (VPN) is used to distribute the Concierge meta-data feed to the population of cable headends that are running the Concierge application.

(vi) Concierge Application Client—The OCAP-certified bound application running on local host devices (e.g., set-top boxes) at the subscriber premises. The client uses Concierge application code objects, meta-data XML pages, and information/graphics objects running as OCAP bound application.

Thus, a method and apparatus for the simultaneous distribution of multiple, different content (e.g., interactive television (iTV)) applications to geographically separated information receivers of differing capabilities has been provided. Many other permutations of the foregoing system components and methods may also be used consistent with the present invention, as will be recognized by those of ordinary skill in the field.

It will also be recognized that while certain aspects of the invention are described in terms of a specific sequence of steps of a method, these descriptions are only illustrative of the broader methods of the invention, and may be modified as required by the particular application. Certain steps may be rendered unnecessary or optional under certain circumstances. Additionally, certain steps or functionality may be added to the disclosed embodiments, or the order of performance of two or more steps permuted. All such variations are considered to be encompassed within the invention disclosed and claimed herein.

While the above detailed description has shown, described, and pointed out novel features of the invention as applied to various embodiments, it will be understood that various omissions, substitutions, and changes in the form and details of the device or process illustrated may be made by those skilled in the art without departing from the invention. The foregoing description is of the best mode presently contemplated of carrying out the invention. This description is in no way meant to be limiting, but rather should be taken as illustrative of the general principles of the invention.

What is claimed:

1. A content-based network system, comprising:
content production apparatus;
network control apparatus; and
communication apparatus, responsive to at least the network control apparatus, said communication apparatus capable of at least communicating with and controlling a plurality of content-related applications executing on a plurality of different network information receivers, said receivers each comprising apparatus adapted to create and uniquely describe a content-related application.

2. The system of claim 1, wherein said content-related applications comprise interactive television (iTV) applications.

3. The system of claim 2, wherein said iTV applications comprise a Java Xlet.

4. The system of claim 3, wherein said network comprises a hybrid fiber coax (HFC) cable television network, and said receivers comprise set-top boxes having radio frequency (RF) tuners.

5. The system of claim 4, wherein said content-related applications are remotely configurable by a network entity.

6. The system of claim 4, wherein at least a portion of said different receivers each comprise heterogeneous hardware or software configurations.

7. The system of claim 2, wherein said information receivers comprise network servers.

8. An interactive television (iTV) application development system, comprising:
a database containing information assets and system events associated with an iTV application; and
apparatus adapted to create an iTV application playlist that is responsive to said database, said playlist being capable of providing unique associations between said information assets and events associated with said iTV application.

9. The system according to claim 8, wherein said unique associations are provided at least in part using an extended markup language (XML).

10. An interactive television (iTV) system, comprising:
a content production system;
a network control system; and
a communication system, in data communication with the network control system which distributes, controls, and communicates with a plurality of different interactive television applications adapted to execute on a plurality of different network connected information receivers;
the iTV system further comprising:
first apparatus adapted to create and uniquely describe an iTV application;
second apparatus adapted to create a database for at least storing and accessing said iTV application and;
third apparatus adapted to create an internal playlist which uniquely describes system events associated with a plurality of said iTV applications.

11. The system of claim 10, wherein said system further comprises:
at least one application content server;
at least one application information server in communication with said at least one content server;
at least one iTV source channel input;
a digital multiplexer in communication with said source input and said information server; and
an automation system in communication with said at least one application information server.

12. Cable television network apparatus, comprising:
first apparatus adapted to control the distribution of multiple, different iTV applications distributed from multiple, different content provider control systems to multiple, different information receivers; and
second apparatus adapted to communicate specific iTV application information data between at least one of said control system and said multiple information receivers.

13. The network apparatus of claim 12, further comprising:
third apparatus adapted to communicate control information between said multiple, different information receivers and at least one of said content provider control system.

14. For use in an interactive television network; (iTV), network apparatus, comprising:
first apparatus adapted to dynamically generate and adapted application code and data objects from received from disparate content providers; and
second apparatus adapted to distribute said generated and adapted code to a plurality of nodes within said network.

15. The network apparatus of claim 14, wherein the application code comprises iTV applications distributed across a plurality of heterogeneous networks, and to geographically separated information receivers each having at least partly different functional capabilities.

16. Receiver apparatus for use in a content-based network, comprising:
apparatus for creating and uniquely describing an iTV application in conjunction with associated information assets and system events;
apparatus for creating a database adapted to store and output at least said iTV application; and
apparatus for creating an internal playlist which uniquely describes system events associated with a plurality of said iTV applications in conjunction with each of said associated information assets.

17. Computer-readable storage apparatus, comprising:
a computer readable medium adapted to store at least one computer program; and
at least one program stored on said medium comprising an extended markup language (XML) model and associated extensions that provide unique associations between one or more information assets associated with an iTV application, and timed events described by an internal iTV application playlist.

18. For use in a content-based network system, apparatus comprising at least one interactive television (iTV) application object generator located within each of a plurality of different networks, said generator comprising:
first apparatus for ingesting, validating, and storing the output from at least one iTV application processing system;
second apparatus for creating at least one iTV application object stream after processing the output from said application processing system; and
third apparatus for outputting said at least one iTV application object stream.

19. A method of operating a content-based network, comprising:
distributing, in a substantially simultaneous fashion, multiple substantially different interactive television (iTV) applications to geographically separated information receivers of differing capabilities;
whereupon said iTV applications are independently selected, loaded, and executed by each of the information receivers.

20. The method of claim 19, wherein said network comprises a hybrid fiber coax (HFC) network having at least one headend, and said information receivers comprise OpenCable (OCAP) compliant set-top boxes operatively coupled to said HFC network.

21. The method of claim 20, further comprising distributing said applications to said receivers via at least one carousel apparatus associated with said network.

22. Receiver apparatus for use in a content-based network, comprising:
a processor;
a network interface in operative communication with said processor; and
at least one interactive television (iTV) client application operative to execute on said receiver apparatus;
wherein said at least one application comprises:
apparatus for receiving application code and data objects from at least one source; and
apparatus for dynamically signaling at least one control system of said network, and providing information relating to at least one of capabilities, general status, and application state of said receiver apparatus thereto.

23. The receiver apparatus of claim 22, wherein said network comprises a hybrid fiber coax (HFC) network having at least one headend, and said receiver apparatus comprises an OpenCable (OCAP) compliant set-top box operatively coupled to said HFC network via said interface, said interface comprising at least on radio frequency tuner.

24. Content provider apparatus adapted for distributing content, comprising:
at least one application content server;
at least one application information server in communication with said at least one content server;
at least one iTV source channel input;
a digital multiplexer in communication with said source input and said information server; and
an automation system in communication with said at least one application information server.

25. The apparatus of claim 24, wherein said source channel input further comprises a digital video/audio encoding apparatus.

26. The apparatus of claim 25, further comprising a satellite communication link in signal communication with said digital multiplexer.

27. A method of operating a customer premises device associated with an interactive network, comprising:
selecting at said device a channel associated with an interactive television (iTV) application;
operating said iTV application to generate one or more user interface outputs, and receive at least one of network, user interface, and iTV application inputs;
generating iTV user information based at least in part on said operating; and
transmitting said iTV user information to a remote network device.

28. The method of claim 27, wherein said device comprises an OpenCable (OCAP) compliant set-top box, and said network comprises a cable television network, and said act of transmitting comprises transmitting via an out-of-band (OOB) RF channel.
